(19) United States
(12) Patent Application Publication
(10) Pub. No.: US 2004/0152366 A1
(43) Pub. Date: Aug. 5, 2004

(54) Rehabilitation kit for closures

(76) Inventors: David J. Schultz, W. Melbourne, FL (US); Tom W. DeBerry, Vero Beach, FL (US); Michael R. Johnson, Ft. Piercie, FL (US)

Correspondence Address: Scott P. Zimmerman, P.O. Box 3822, Cary, NC, 27519, US

(21) Appl. No.: 10/355,789

(22) Filed: Jan. 31, 2003

(51) Int. Cl. H01R 9/22

(52) U.S. Cl. 439/709

(57) ABSTRACT

An apparatus and a method is disclosed for rehabilitating an existing telecommunications closure. The method removes an internal mounting plate from the existing closure. The internal mounting plate is replaced with a closure rehabilitation kit. The closure rehabilitation kit has a mounting plate and means for grasping the mounting plate to insert the mounting plate into the existing telecommunications closure. The closure rehabilitation kit extends the service life of the existing telecommunications closure.

A portion of the disclosure of this patent document and its figures contain material subject to copyright protection. The copyright owner has no objection to the facsimile reproduction by anyone of the patent document or the patent disclosure, but the copyright owner otherwise reserves all copyrights whatsoever.

### BACKGROUND OF THE INVENTION

1. Field of the Invention

This invention generally relates to electrical conductors and, more particularly, to closures housing conductors.

2. Description of the Related Art

Closures are commonly used to protect and to shield conductors. The term “closure” includes closures, enclosures, terminals and other devices that are used to house conductors—the wires, cables, coaxial cables, fiber optic cables, and other mediums that carry, or “conduct,” electrons from one location to another location. These closures are available in many sizes and configurations and are used throughout the utility, telecommunications, cable, and electronics industries.

The telecommunications industry, for example, protects conductors within closure assemblies. Telecommunications service providers commonly connect one or more conductors within an above-ground pedestal closure or within a buried box-like closure. One end of a conductor is terminated within a housing and then spliced with another conductor. Where, for example, telecommunications service lines extend from a main cable to a customer's premises, a connection is needed between the main cable and the service lines. The main cable and the service line are connected at a terminal block within the housing, and the housing helps protect the terminal block from ambient conditions, from rodents, and from damage.

The housing may have a long service life. Some older residential neighborhoods, in fact, have telecommunications housings that were installed thirty (30), forty (40), or even fifty (50) years ago. The housing fades and corrodes, but the housing still functions. The terminal block within the housing, however, deteriorates over the years and degrades the customer's telecommunications service. The terminal block, for example, corrodes over time and causes static on the customer's telephone line. Even though the housing itself is adequate, the deteriorated terminal block within the housing is not properly functioning.

FIG. 1 is a schematic illustrating an example of a prior art closure assembly 10. This closure assembly 10 is used within the telecommunications industry and is commonly found throughout many communities. The closure assembly 10 comprises a housing 12, an internal mounting plate 14, and a terminal block 16 mounted to the mounting plate 14. The closure assembly 10 is representative of many installations throughout many communities. During the 1960's and 1970's the housing 12 was originally manufactured by the Reliable Electric Company of Cleveland, Ohio. The corporate successor to the Reliable Electric Company (e.g., RELTEC), however, is today owned by MARCONI® Communications, and the same or similar closures are now sold as their UPCBD3, 4, and 5 family of distribution housings (MARCONI® is a registered trademark of Marconi Communications plc, c/o Marconi Intellectual Property, Marrable House, The Vineyards, Great Baddow, Chelmsford Essex CM2 7QS United Kingdom, Tel: +44-(0)-1245-707600, www.marconi.com). Although the terminal block 16 may have many configurations, the terminal block 16 in the older installations is of the post-type. That is, the terminal block 16 has one or more threaded binding posts 18. These threaded binding posts 18 connect the service line(s) from the customer's premises to the main cable of the telecommunications network. The threaded binding posts 18 are made of a metal material and are susceptible to corrosion. As the years pass the terminal block 16 corrodes and degrades the customer's telecommunications service. The customer, for example, may hear static on their telephone line. So, although the housing 12 also ages, the housing 12 still adequately shelters the terminal block 16. The housing 12, then, is not the source of the static.

Although the corroded terminal block 16 is the cause of the static, the standard procedure heretofore has been to replace the entire closure assembly 10. That is, the housing 12, although not the source of the static, is replaced. A repair crew is dispatched to remove the existing closure assembly 10 and install a new assembly. Even though the existing housing 12 is adequate, the repair crew replaces the existing housing 12 with a new housing. Because the existing housing 12 is not the root of the customer's static, removing and replacing the existing housing 12 is not an efficient use of time or of money. This procedure is especially wasteful when the existing housing 12 is partially buried in the ground. Special crews with special digging equipment must be dispatched. There is, accordingly, a need in the art for a less expensive and a less time-consuming procedure when repairing aged, deteriorated terminal blocks housed within housings.

### BRIEF SUMMARY OF THE INVENTION

This invention is an apparatus and a method for rehabilitating existing telecommunications closures. This apparatus and method allows the existing closure installation to be preserved while repairing the internal, deteriorated terminal. This invention provides a replacement mounting plate and a new terminal block. The mounting plate is installed in the existing housing, and a new terminal block can then be secured to the mounting plate. The existing wiring is then connected to the new terminal, all without replacing the existing housing. Because the existing housing installation is preserved, this invention saves time and money when repairing existing installations.

One embodiment of this invention describes an apparatus for rehabilitating existing telecommunications closures. This apparatus comprises a mounting plate for the telecommunications closure. The mounting plate comprises a surface for mounting a terminal block thereto, and the terminal block is for connecting a service wire to a telecommunications network. The mounting plate comprises means for positioning the mounting plate within the telecommunications closure. The mounting plate further comprises means for grasping the mounting plate to insert the mounting plate into the telecommunications closure. The mounting plate provides a rehabilitation kit for the telecommunications closure. The means for grasping the mounting plate can comprise a handle and/or a knob.

Another embodiment describes a method for rehabilitating an existing telecommunications closure installation. This method removes an internal mounting plate from the existing telecommunications closure. The existing telecommunications closure houses wiring for a telecommunications network. The internal mounting plate is replaced with a closure rehabilitation kit. The closure rehabilitation kit comprises a mounting plate and means for grasping the mounting plate to insert the mounting plate into the existing telecommunications closure. The closure rehabilitation kit extends the service life of the existing telecommunications closure.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIG. 1 is a schematic illustrating a prior art closure;

FIG. 2 is a schematic illustrating an embodiment of this invention;

FIG. 3 is a schematic illustrating another embodiment of this invention;

FIG. 4 is a schematic illustrating still another embodiment of this invention; and

FIG. 5 is a flowchart showing a method of rehabilitating an existing telecommunications closure.

### DETAILED DESCRIPTION OF THE INVENTION

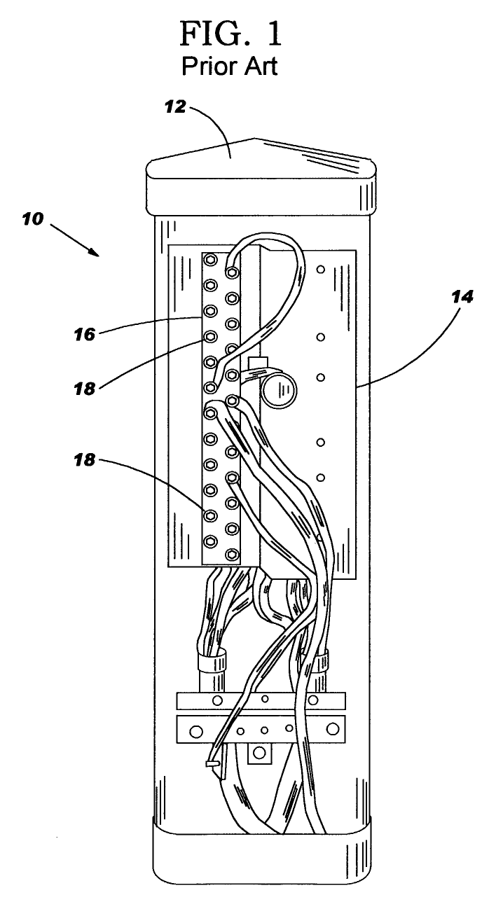

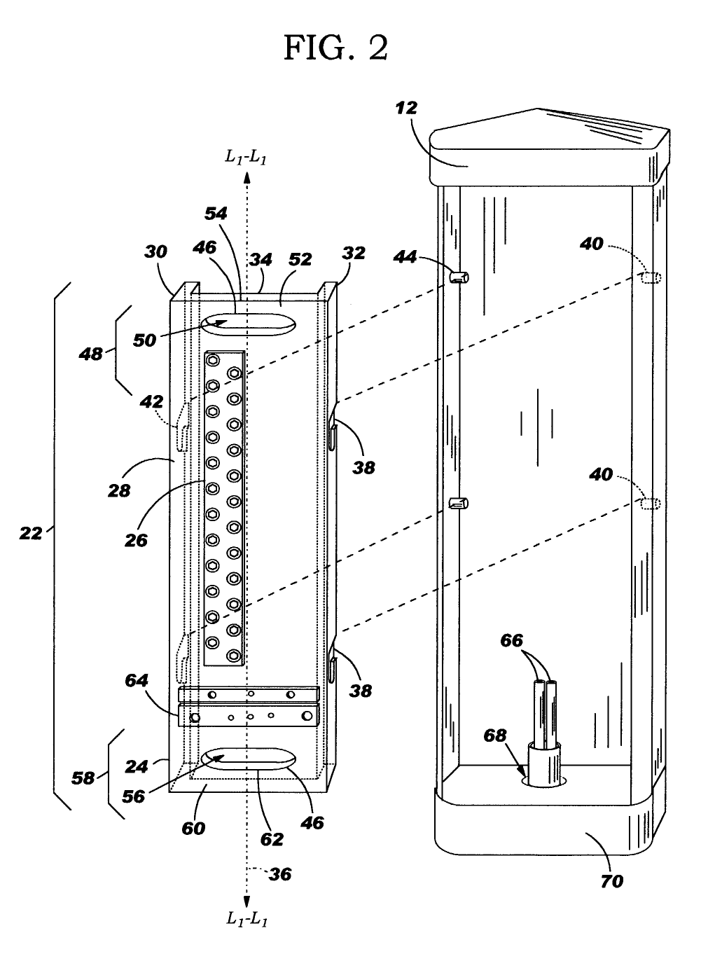

FIG. 2 is a schematic illustrating an embodiment of this invention. FIG. 2 shows a closure rehabilitation kit 22. The closure rehabilitation kit 22 comprises a mounting plate 24 and a new terminal block 26. The closure rehabilitation kit 22 allows the existing closure 12 to be rehabilitated to extend its service life. The closure rehabilitation kit 22 replaces the internal mounting plate and the deteriorated terminal block (shown, respectively, as reference numerals 14 and 16 in FIG. 1) while preserving the existing closure 12. The mounting plate 24 inserts into the existing closure 12 and replaces the removed mounting plate. While the mounting plate 24 may have any size or configuration to suit a particular closure, prototypes of this closure rehabilitation kit 22 have been installed in the MARCONI® UPCBD3, 4, and 5 family of distribution closures (MARCONI® is a registered trademark of Marconi Communications plc, c/o Marconi Intellectual Property, Marrable House, The Vineyards, Great Baddow, Chelmsford Essex CM2 7QS United Kingdom, Tel: +44-(0)-1245-707600, www.marconi.com).

The mounting plate 24 has a front side 28, a left side 30, and a right side 32. The left side 30 and the right side 32 each rearwardly extend from the front side 28 to form a generally “U”-shaped cross-section 34 of the mounting plate 24. The mounting plate 24 may also have an elongate shape defining a longitudinal axis L₁-L₁ (shown as reference numeral 36). The terminal block 26 can be secured to the mounting plate 24, and the terminal block 26 connects at least one conductor to another conductor. The preferred embodiment of the mounting plate 24 has a length of about fifteen inches (15 in.) and a width of about six inches (6 in.). The left side 30 and the right side 32 each have a width of about three inches (3 in.). These dimensions mostly approximate the dimensions of the replaced internal mounting plates (shown as reference numeral 14 in FIG. 1) in the community containing the prototype installations. The mounting plate 24, however, may have any dimensions that suit a particular manufacturer's closure size and design.

The mounting plate 24 comprises means for positioning the mounting plate 24 within the closure 12. The means for positioning the mounting plate 24 preferably comprises a slot and pin arrangement. The right side 32, for example, may comprise a slot 38 for engaging a corresponding pin 40 in the existing closure 12. The right side 32 of the mounting plate 24 is thus suspended from the pin 40. The left side 30 also comprises a slot 42 for engaging a corresponding pin 44 in the closure 12, with the left side 30 of the mounting plate 24 being suspended from the pin 44. The slot may have many configurations (e.g., open ended, hook-shaped, “T”-shaped, etc.), and the right 32 and the left sides 30 may each have more than one slot. The means for positioning the mounting plate 24, however, may comprise threaded fasteners, rivets, clips, retainers, hooks, eyelets, plastic ties, wires, adhesives, and welds. A threaded bolt or screw, for example, could secure the mounting plate 24 within the closure 12.

The mounting plate 24 may also comprise means for grasping the mounting plate. This means for grasping the mounting plate 24 helps a user insert the mounting plate 24 into the closure 12. As FIG. 2 shows, the mounting plate 24 may also comprise a top region 48. The top region 48 has an upper aperture 50 and an upper cross-rib 52. The upper cross-rib 52 separates the upper aperture 50 from a top edge 54 of the front side 28. The aperture 50 allows the user to insert their hand through the aperture 50 and grasp the mounting plate 24. The upper cross-rib 52 may also form a handle 46 around which a user curls their hand (not shown). The fingers of the hand curl through the upper aperture 50. The upper aperture 50 is thus sized to accept the combined width of the four (4) fingers of the user's hand. The front side 28 may also comprise a lower aperture 56 in a bottom region 58. A lower cross-rib 60 separates the lower aperture 56 from a bottom edge 62 of the front side 28. The lower cross-rib 60, likewise, forms the handle 46 around which the user curls their hand, and the fingers of the hand curl through the lower aperture 56. The cross-ribs 52 and 60 may have a flat, plate-like construction. The cross-ribs 52 and 60, however, preferably have a cylindrical outer shape with a contoured/ergonomic gripping surface. The upper aperture 50 and the lower aperture 56 preferably have dimensions of about five inches (5 in.) in width and about five inches (5 in.) in height to permit the user to insert the palm of their hand. While there is perhaps great variability in the size of a hand from one user to another user, the dimensions of the apertures 50 and 56 are preferably chosen to correspond to a majority percentile of the population.

The mounting plate 24 preferably has a single-piece construction. The mounting plate 24 is also preferably constructed of a nonconductive material. The mounting plate 24, for example, could be molded of a polymer material. The mounting plate 24, however, could also be constructed of a partially-conductive material, a metallic material, a ceramic material, a glass material, a fiber or fiber-reinforced material, a wood-based material, a paper-based material, and/or a pulp-based material. Because the mounting plate is preferably molded from a polymer material, the mounting plate 24 is less susceptible to corrosion and, thus, may have a longer life. The polymer construction also reduces the occurrences of sharp edges/corners (as in a metallic construction), thus also reducing damage to the wires in the closure 12. The preferred nonconductive, polymer construction also electrically insulates the mounting plate 24, thus reducing the instances of stray voltage on the mounting plate 24. The polymer construction is also lighter in weight, thus reducing fatigue during user handling.

The mounting plate 24 may also comprise a ground plate 64. The ground plate 64 is constructed of a conductive material and connected to electrical ground. Because the mounting plate 24 is preferably molded of a nonconductive, polymer material, the ground plate 64 provides a connection to electrical ground. The ground plate 64 is preferably located proximate to the bottom region 58 of the mounting plate 24. This lower location provides added flexibility when cutting and splicing wires 66. Because the wires 66 generally enter the closure 12 from an aperture 68 in the bottom 70 of the closure 12, the user has more length to work with when moving the wires 66.

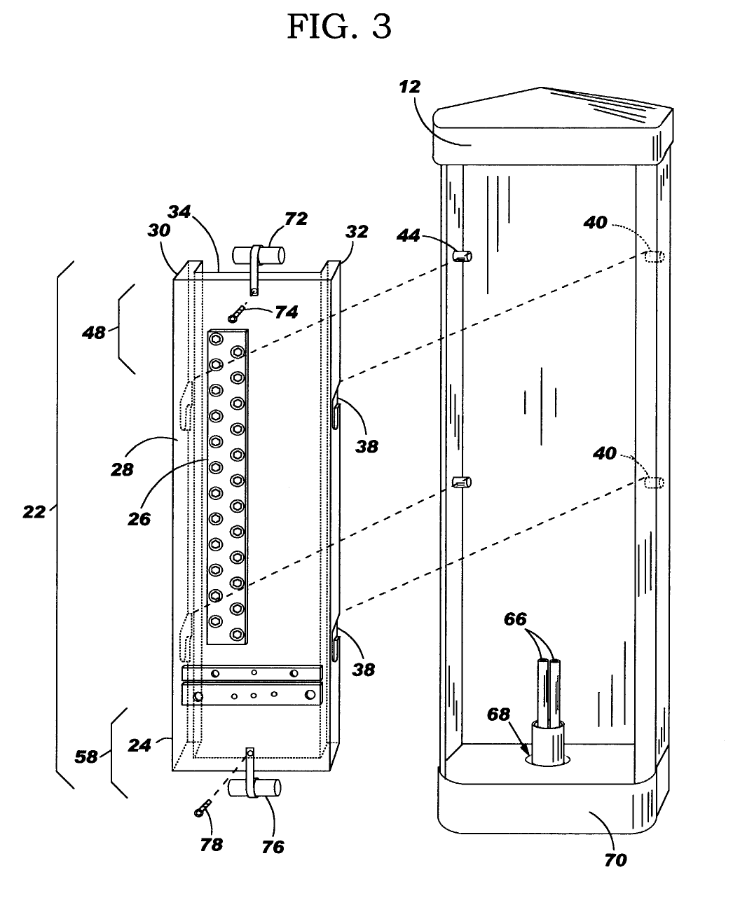

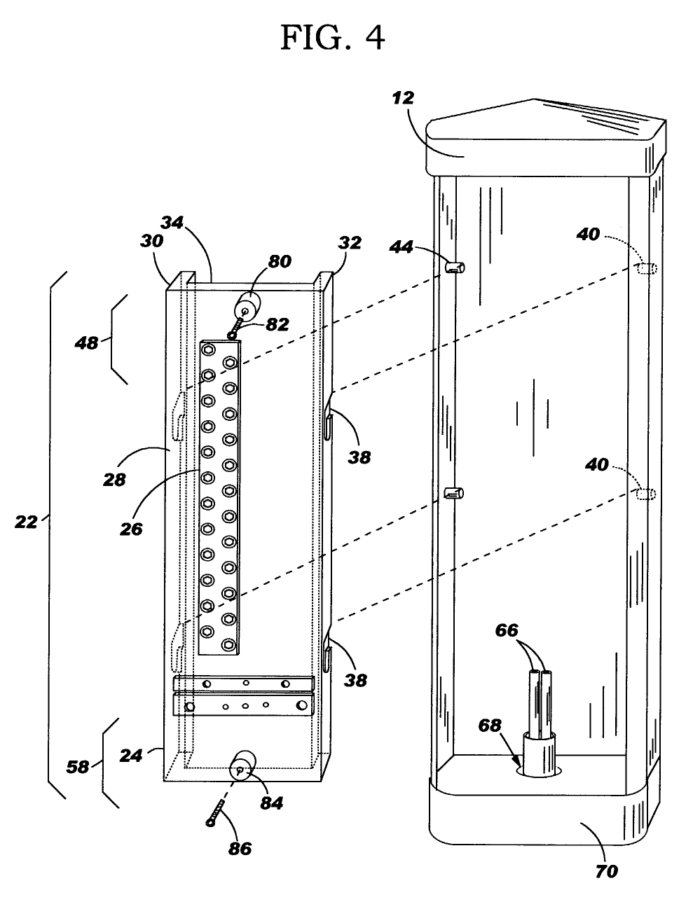

FIGS. 3 and 4 are schematics illustrating other means for grasping the mounting plate 24. FIG. 3 shows the mounting plate 32 comprising a top handle 72. Here the top handle 72 attaches to the mounting plate 32. The top handle 72 could, for example, attach to the top region 48 of the mounting plate 32 by one or more threaded fasteners 74. A bottom handle 76 could also attach by one or more threaded fasteners 78 at the bottom region 58 of the mounting plate 32. Either handle 72 or 76, however, could be attached using rivets, clips, retainers, hooks, barbs, prongs, plastic ties, wires, adhesives, and welds. While the top handle 72 and the bottom handle 76 are preferred, the means for grasping the mounting plate 24 could comprise a handle in a middle portion of the mounting plate 32 and/or a handle in either the left side 30 or the right side 32.

FIG. 4 shows the means for grasping the mounting plate may comprise a knob 80. The knob 80 could be integrally constructed with the mounting plate 32. The knob 80, for example, could be integrally molded with the preferred polymer mounting plate 32. The knob 80, however, could also be a separate component that attaches to the mounting plate 32. The knob 80 could attach to the top region 48 of the mounting plate 32 by one or more threaded fasteners 82. A bottom knob 84 could also attach by one or more threaded fasteners 86 at the bottom region 58 of the mounting plate 32. Either knob 80 or 84, however, could be attached using rivets, clips, retainers, hooks, barbs, prongs, plastic ties, wires, adhesives, and welds. While the top knob 80 and the bottom knob 84 are preferred, the means for grasping the mounting plate 24 could comprise a knob in a middle portion of the mounting plate 32 and/or a knob in either the left side 30 or the right side 32.

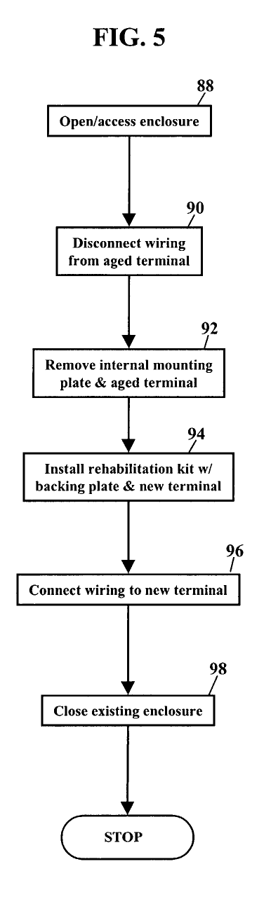

FIG. 5 is a flowchart showing a method of rehabilitating an existing closure. The closure is opened or accessed (Block 88) and any wiring is disconnected from the deteriorated terminal block (Block 90). The internal mounting plate, with the deteriorated terminal block, is removed (Block 92). A closure rehabilitation kit is installed (Block 94), and the closure rehabilitation kit comprises a mounting plate and a new terminal block secured to the mounting plate. The mounting plate has at least one handle for inserting into the existing closure. The mounting plate replaces the removed mounting plate. The closure rehabilitation kit extends the service life of the existing closure. Once the rehabilitation kit is installed, the wiring is connected to the new terminal (Block 96). The closure is then closed (Block 98).

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. An apparatus, comprising:
a mounting plate for a closure, the mounting plate comprising a surface for mounting a terminal block thereto, the terminal block for connecting at least one conductor to another conductor;
the mounting plate comprising means for positioning the mounting plate within the closure; and
the mounting plate further comprising means for grasping the mounting plate to insert the mounting plate into the closure,
wherein the mounting plate provides a rehabilitation kit for the closure.

2. An apparatus according to claim 1, wherein the means for grasping the mounting plate comprises a handle.

3. An apparatus according to claim 1, wherein the means for grasping the mounting plate comprises a knob.

4. An apparatus according to claim 1, wherein the means for grasping the mounting plate comprises an aperture in the mounting plate.

5. An apparatus according to claim 1, wherein the means for grasping the mounting plate comprises an aperture in the mounting plate and a cross-rib, the cross-rib separating the aperture from an edge of the mounting plate, the cross-rib forming a handle around which a user curls their hand, the fingers of the hand curling through the aperture and grasping the cross-rib, thus allowing the user to insert the mounting plate into the closure.

6. An apparatus according to claim 5, wherein the aperture and the cross-rib are proximate a top region of the mounting plate, the cross-rib separating the aperture from a top edge of the mounting plate, the cross-rib forming the handle around which the user curls their hand, the fingers of the hand curling through the aperture and grasping the cross-rib.

7. An apparatus according to claim 5, wherein the aperture and the cross-rib are proximate a bottom region of the mounting plate, the cross-rib separating the aperture from a bottom edge of the mounting plate, the cross-rib forming the handle around which the user curls their hand, the fingers of the hand curling through the aperture and grasping the cross-rib.

8. An apparatus according to claim 1, wherein the mounting plate is molded from a polymer material.

9. An apparatus according to claim 1, wherein the mounting plate further comprises a ground plate, the ground plate for connection to electrical ground.

10. An apparatus according to claim 9, wherein the ground plate is located proximate to a bottom region of the mounting plate.

11. An apparatus according to claim 1, further comprising the terminal block.

12. An apparatus according to claim 1, wherein the means for positioning the mounting plate within the closure comprises a slot for engaging a corresponding pin in the closure, the mounting plate being suspended from the pin.

13. An apparatus according to claim 1, wherein the mounting plate further comprises a front side and a left side, the left side rearwardly extending from the front side, and the means for positioning the mounting plate within the closure comprising a slot in the left side, the slot for engaging a corresponding pin in the closure, the mounting plate being suspended from the pin.

14. An apparatus according to claim 1, wherein the mounting plate further comprises a front side and a right side, the right side rearwardly extending from the front side, and the means for positioning the mounting plate within the closure comprising a slot in the right side, the slot for engaging a corresponding pin in the closure, the mounting plate being suspended from the pin.

15. A method, comprising:
removing an internal mounting plate from an existing closure, the housing a terminal block for connecting at least one conductor to another conductor;
replacing the internal mounting plate with a closure rehabilitation kit, the closure rehabilitation kit comprising a mounting plate and means for grasping the mounting plate to insert the mounting plate into the closure,
wherein the closure rehabilitation kit extends the service life of the existing closure.

16. A method according to claim 14, wherein the means for grasping the mounting plate comprises a handle.

17. A method according to claim 14, wherein the means for grasping the mounting plate comprises a knob.
